(19) United States
(12) Patent Application Publication
(10) Pub. No.: US 2006/0208694 A1
(43) Pub. Date: Sep. 21, 2006

(54) Method & apparatus to provide a programmable waveform generator battery charger

(76) Inventor: John Fee, Garland, TX (US)

Correspondence Address: JACKSON WALKER LLP, 901 MAIN STREET, SUITE 6000, DALLAS, TX, 75202-3797, US

(21) Appl. No.: 11/363,571

(22) Filed: Feb. 27, 2006

Related U.S. Application Data
(60) Provisional application No. 60/656,284, filed on Feb. 25, 2005.
(60) Provisional application No. 60/657,091, filed on Feb. 25, 2005.
(60) Provisional application No. 60/656,285, filed on Feb. 25, 2005.
(60) Provisional application No. 60/656,283, filed on Feb. 25, 2005.

(51) Int. Cl. H02J 7/00

(52) U.S. Cl. 320/110

(57) ABSTRACT

One embodiment of the present invention comprises a charger having a mechanism where the battery charger “reads” the battery personality and automatically adjusts the battery charging algorithm to suit the battery type.

### CLAIM OF PRIORITY

This application claims priority of U.S. Provisional application Ser. No. 60/656,284 filed Feb. 25, 2005, entitled “Method & Apparatus to Provide Adaptive Variable Frequency Charging Pulses to Nickel and SLA Battery Types”; U.S. Provisional application Ser. No. 60/657,091 filed Feb. 25, 2005, entitled “Method & Apparatus to Ensure That Saturation Of the Battery Does Not Occur During Resonant Finding Phase As Well As Implementation Methods To Quickly Find Resonance”; U.S. Provisional application Ser. No. 60/656,285 filed Feb. 25, 2005 entitled “Method and Apparatus to Provide Charging Waveform To Lithium Ion Batteries”; and U.S. Provisional application Ser. No. 60/656,283, filed Feb. 25, 2005, entitled “Method and Apparatus to Provide Programmable Waveform Generator Battery Charger”.

Problem: Today's chargers mainly consist of fixed charging methods either by mechanisms as fixed current and voltage or a fixed charging method. The problem is that each battery possesses a different “personality” in which the charging method including waveform and other important parameters such as voltage, current, coulombic transfer, etc, should be adaptable to the individual battery. In the past charging has been developed in which “smart chargers” read the battery type and then apply a charging method, usually limited by voltage, current, or temperature. This results in inefficient and inaccurate matching of the battery charging method to the particular battery.

### BRIEF DESCRIPTION OF DRAWINGS

FIG. 1 is a block diagram of charger reading a battery; and

FIG. 2 is a block diagram of a charger determining a battery resonance.

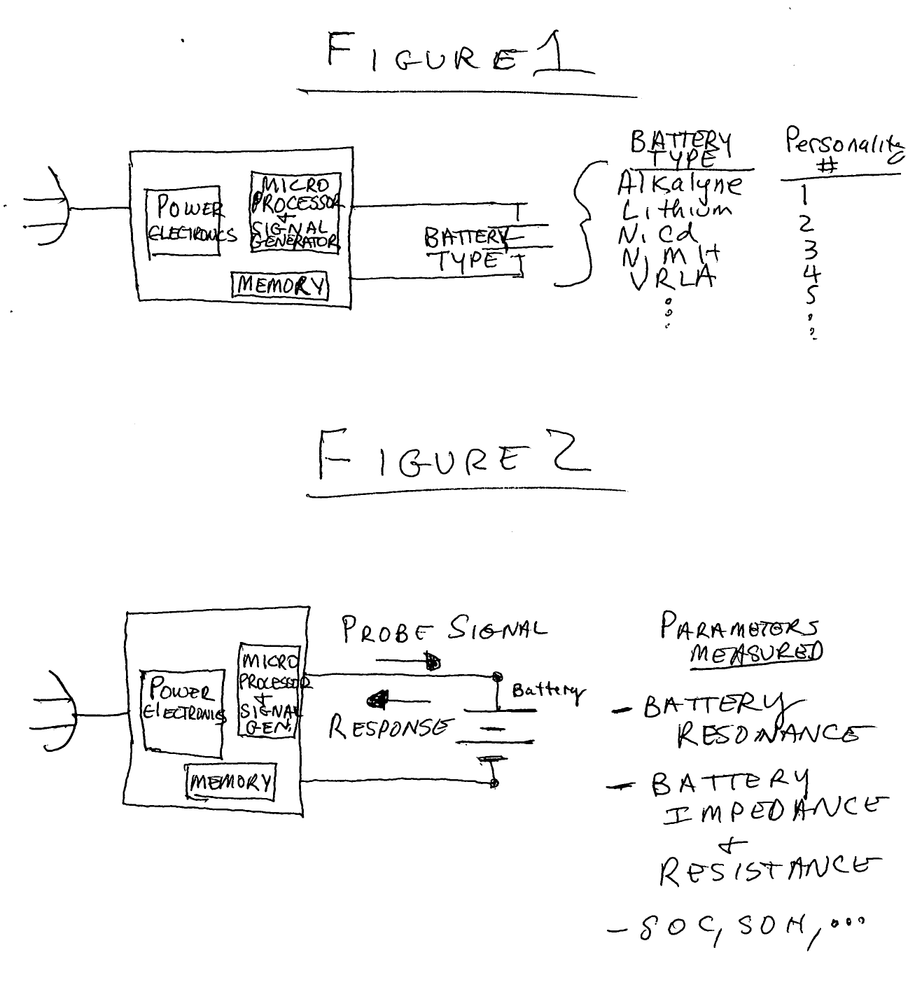

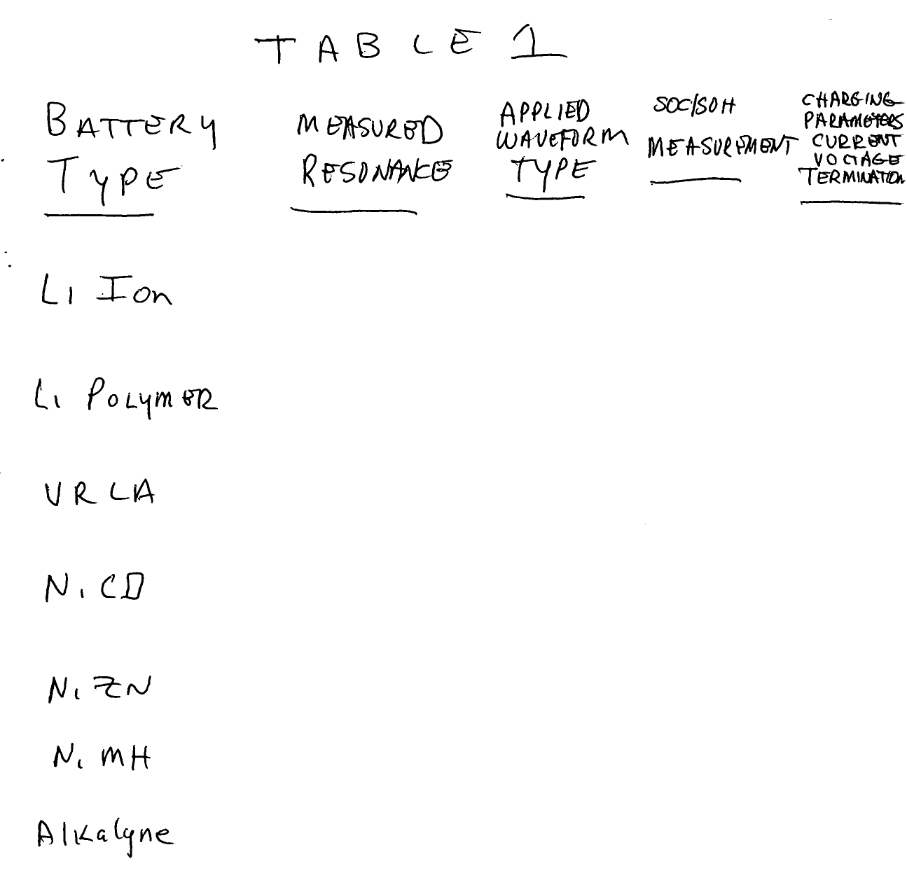

Solution: One embodiment of the present invention comprises a charger having a mechanism where the battery charger “reads” the battery personality and automatically adjusts the battery charging algorithm to suit the battery type. FIG. 1 describes one embodiment of the invention comprising a method of reading the battery personality for use in a charging algorithm, whilst FIG. 2 describes a second embodiment of the invention comprising a method to automatically determine battery resonance as a method to determine State Of Charge and State Of Health. These methods are integrated into the charger thereby resulting in the ability to match the charger algorithm to the battery type. The programmable, adaptive charger reads the battery parameters (resonance, SOC, SOH, impedance, etc) and then automatically adapts the algorithm to match the battery type. The charger maintains a database of algorithms and waveforms, usually in Linux or other such that these waveforms can be called upon (similar to a signal generator with multiple waveforms) to fit the particular battery type, such as shown in Table 1. The charger may consist of a computer or microprocessor, programmable waveforin generator controlled by the computer, sensing devices (such as thermistors, etc).

We claim:

1. A battery charger adapted to charge a battery as a function of the battery personality.
